(19) United States
(12) Patent Application Publication
(10) Pub. No.: US 2025/0142588 A1
(43) Pub. Date: May 1, 2025

(54) DCI FOR CELL DTX/DRX CONFIGURATION AND CELL TURN-OFF

(71) Applicant: Lenovo (Singapore) Pte. Ltd., New Tech Park (SG)

(72) Inventors: Vijay Nangia, Woodridge, IL (US); Ahmed Hindy, Aurora, IL (US)

(21) Appl. No.: 18/820,009

(22) Filed: Aug. 29, 2024

Related U.S. Application Data
(60) Provisional application No. 63/595,309, filed on Nov. 1, 2023.

(51) Int. Cl. H04W 72/232

(52) U.S. Cl. CPC H04W 72/232

(57) ABSTRACT

Various aspects of the present disclosure relate to receiving, from a network entity, a cell discontinuous transmission and/or reception (DTX/DRX) configuration for a plurality of serving cells. Aspects of the present disclosure may relate to receiving a downlink control information (DCI) signal for a serving cell corresponding to at least the cell DTX/DRX configuration, wherein the DCI further comprises an indication of a cell turn-off. Aspects of the present disclosure may further relate to performing a cell search based at least in part on the cell turn-off and the cell DTX/DRX configuration.

### TECHNICAL FIELD

The present disclosure relates to wireless communications, and more specifically to enhanced downlink control information (DCI) for indicating a joint cell discontinuous transmission and/or discontinuous reception (DTX/DRX), as well as indicating whether a cell is turning off.

### BACKGROUND

A wireless communications system may include one or multiple network communication devices, such as base stations, which may be otherwise known as an evolved NodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology (RAT), fourth generation (4G) RAT, fifth generation (5G) RAT, among other suitable RATs beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include means for receiving, from a network entity, a cell discontinuous transmission and/or discontinuous reception (DTX/DRX) configuration for a plurality of serving cells. The method and apparatuses described herein may include means for receiving a DCI signal for a serving cell corresponding to at least the cell DTX/DRX configuration, wherein the DCI signal further comprises an indication of a cell turn-off. The method and apparatuses described herein may include means for performing a cell search based at least in part on the cell turn-off and the cell DTX/DRX configuration.

In some implementations, the method and apparatuses described herein may further include means for transmitting, to a UE, a cell DTX/DRX configuration for a plurality of serving cells. The method and apparatuses described herein may include means for transmitting a DCI signal for a serving cell corresponding to at least the cell DTX/DRX configuration, wherein the DCI signal further comprises an indication of a cell turn-off. The method and apparatuses described herein may include means for deactivating the serving cell based at least in part on the cell turn-off and the cell DTX/DRX configuration.

### BRIEF DESCRIPTION OF THE DRAWINGS

FIG. 1 illustrates an example of a wireless communications system in accordance with aspects of the present disclosure.

FIG. 2 illustrates an example of a protocol stack for wireless communication, in accordance with aspects of the present disclosure.

FIG. 3A illustrates an example of an abstract syntax notation 1 (ASN.1) representation of a discontinuous reception (DRX) configuration information element (IE), in accordance with aspects of the present disclosure.

FIG. 3B is a continuation of the DRX configuration IE of FIG. 3A.

FIG. 4 illustrates an example of an ASN.1 representation of a cell DTX/DRX configuration IE, in accordance with aspects of the present disclosure.

FIG. 5 illustrates an example of a user equipment (UE) 500, in accordance with aspects of the present disclosure.

FIG. 6 illustrates an example of a processor 600, in accordance with aspects of the present disclosure.

FIG. 7 illustrates an example of a network equipment (NE) 700, in accordance with aspects of the present disclosure.

FIG. 8 illustrates a flowchart of a method performed by a UE, in accordance with aspects of the present disclosure.

FIG. 9 illustrates a flowchart of a method performed by a NE, in accordance with aspects of the present disclosure.

### DETAILED DESCRIPTION

Generally, the present disclosure describes systems, methods, and apparatuses for cell measurement and access to network energy saving cells. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

For 5G NR, one of the fundamental challenges towards more efficient network implementation is energy consumption. While devices at the user end are usually perceived as the main target for further energy savings, the need for further reduction on energy consumption at the network end is gaining more traction owing to the higher running costs, as well as the lack of ubiquitous energy supply from renewable energy sources, which are becoming more widely implemented due to environmental regulations and companies' initiatives to cut carbon emissions.

One way of achieving such network energy savings is via cell discontinuous transmission (DTX), and/or cell discontinuous reception (DRX), wherein a cell suspends the transmission and/or reception of a selected set of signals/channels for a configured period of time for the sake of energy saving. Clearly, one downside of cell DTX and/or DRX is the degraded network performance due to the inactivity of the cell during cell DTX and/or cell DRX inactive periods.

To solve the problems with network energy consumption discussed herein, the present disclosure describes techniques for joint Layer 1 (L1) triggering of cell DTX and/or cell DRX along with cell turn-off indicated to a UE group. Beneficially, the indication of cell turn-off allows the UE group to proactively seek another cell, thereby avoiding service disruption from the cell turn-off. More specifically, the present disclosure describes an enhanced cell DTX/DRX configuration that enables the following solutions:

According to aspects of a first solution, the enhanced cell DTX/DRX configuration enables an enhanced physical downlink control channel (PDCCH) with DCI format that supports joint L1 triggering of cell DTX/DRX, and cell turn-off, where the DCI fields included in the PDCCH transmission are based on at least a higher-layer configuration of cell DTX/DRX, and a higher-layer configuration of cell turn-off being either enabled or disabled.

According to aspects of a second solution, the enhanced cell DTX/DRX configuration enables a priority rule for applicability of a cell turn-off indicator over a cell DTX/DRX indicator in the DCI, wherein the cell turn-off indicator overrides the cell DTX/DRX indicator, if the cell turning off is triggered.

According to aspects of a third solution, the enhanced cell DTX/DRX configuration enables an application time, T_{AP}, is defined for the cell turning off, wherein the cell turn-off is applied after T_{AP} time units (e.g., slots or ms) relative to the time of receiving the DCI.

Aspects of the present disclosure are described in the context of a wireless communications system. Note that one or more aspects from different solutions may be combined.

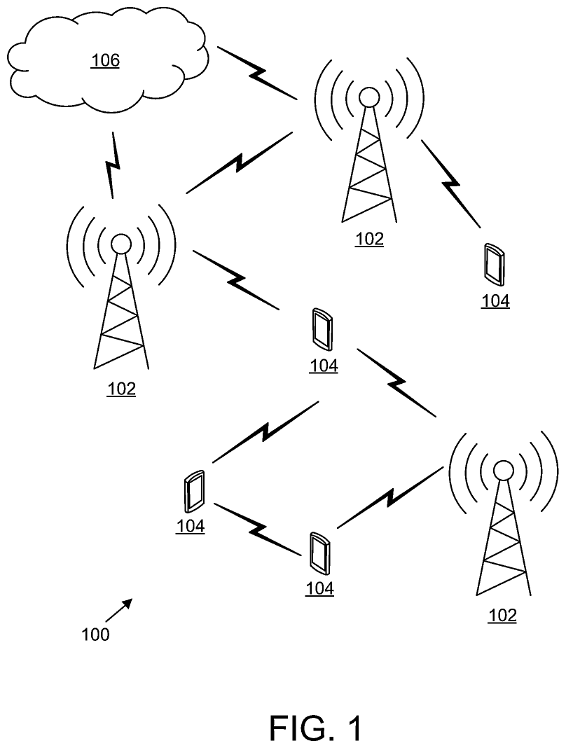

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a long-term evolution (LTE) network or an LTE-advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Wireless communication in unlicensed spectrum (also referred to as “shared spectrum”) in contrast to licensed spectrum offer some obvious cost advantages allowing communication to obviate overlaying operator's licensed spectrum and rather use license free spectrum according to local regulation in specific geographies. From the third generation partnership project (3GPP) technology perspective, the unlicensed operation can be on the Uu interface (referred to as NR-U) or also on sidelink interface (e.g., SL-U).

For initial access, a UE 104 detects a candidate cell and performs downlink (DL) synchronization. For example, the gNB (e.g., an embodiment of the NE 102) may transmit a synchronization signal and broadcast channel (SS/PBCH) transmission, referred to as a synchronization signal block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB. Note that with beam-based communication, each DL beam may be associated with a respective SSB.

After performing DL synchronization and acquiring essential system information, such as the master information block (MIB) and the system information block type 1 (SIB1), the UE 104 performs uplink (UL) synchronization and resource request by performing a random access procedure, referred to as “RACH procedure” by selecting and transmitting a preamble on the physical random access channel (PRACH). The PRACH preamble is transmitted during a RACH occasion, i.e., a predetermined set of time-frequency resources that are available for the reception of the PRACH preamble. Note that with beam-based communication, the UE 104 may select a certain DL beam and transmit the PRACH preamble on a corresponding UL beam. In such embodiments, there may be a mapping between SSB and RACH occasion, allowing the network to determine which beam the UE 104 has selected.

To complete the RACH procedure, after transmitting the PRACH preamble (also referred to as “Msg1”), the UE 104 monitors for a random-access response (RAR) message (also referred to as “Msg2”). The gNB transmits UL timing adjustment information in the RAR and may also schedule an UL resource, referred to as an initial uplink grant.

In 3GPP new radio (NR), the gNB may transmit the maximum 64 SSBs and the maximum 64 corresponding copies of physical downlink control channel (PDCCH) and/or physical downlink shared channel (PDSCH) for delivery of SIB1 in high frequency bands (e.g., 28 GHZ). This may cause significant network energy consumption even for a very low traffic load condition. According to 3GPP technical report (TR) 38.864 (v18.1.0), for network energy savings, on-demand SSB and/or SIB1 (SSB/SIB1) transmissions and a cell without SSB/SIB1 transmission were considered. When a cell does not transmit SSB/SIB1, for a UE to access the cell, the UE should obtain SI of the cell from other associated carriers/cells and synchronize from other associated carriers/cells. When a cell is in a long period of cell inactivity, a UE served by the cell can trigger SSB/SIB1 transmissions by sending a request to the cell.

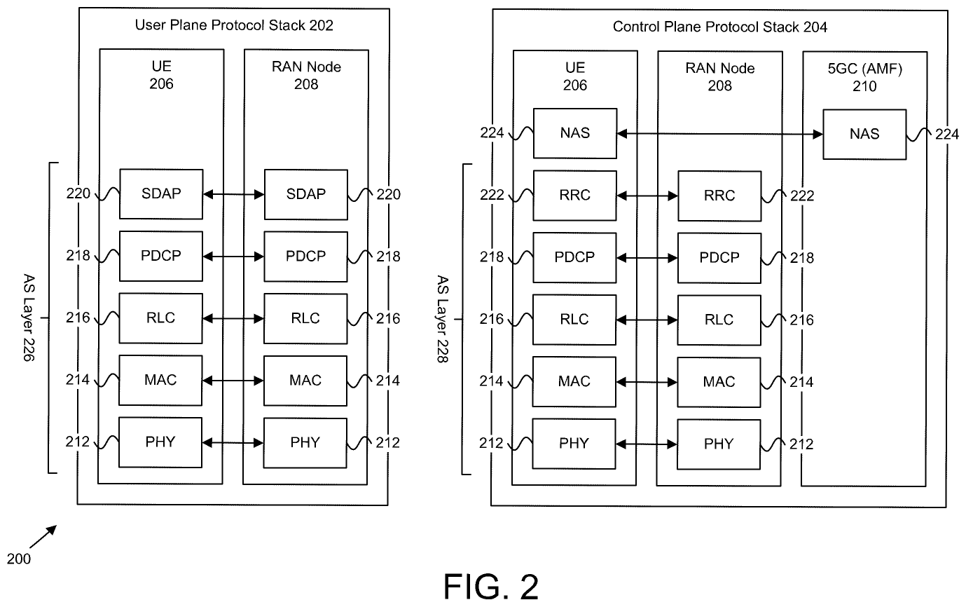

FIG. 2 illustrates an example of a protocol stack 200, in accordance with aspects of the present disclosure. In some embodiments, the protocol stack 200 may be a NR protocol stack. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a PHY layer 212, a MAC sublayer 214, a radio link control (RLC) sublayer 216, a packet data convergence protocol (PDCP) sublayer 218, and a service data adaptation protocol (SDAP) layer 220. The control plane protocol stack 204 includes a PHY layer 212, a MAC sublayer 214, a RLC sublayer 216, and a PDCP sublayer 218. The control plane protocol stack 204 also includes a radio resource control (RRC) layer 222 and a non-access stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP sublayer 220, PDCP sublayer 218, RLC sublayer 216, and MAC sublayer 214. The Layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of carrier aggregation and/or dual connectivity. The RRC layer 222 also manages the establishment, configuration, maintenance, and release of SRBs and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as transport blocks (TBs)) from MAC service data units (SDUs) received through logical channels, and the MAC sublayer 214 in the receiving side recovers MAC SDUs from MAC PDUs received through transport channels.

In the radio protocol architectures described herein, the term “SDU” refers to a data unit that is received by a sublayer from a higher sublayer, or that is sent by a sublayer to a higher sublayer. Likewise, the term “PDU” refers to a data unit that is sent by a sublayer to a lower sublayer, or that is received by a sublayer from a lower sublayer.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some embodiments, the protocol stack 200 may be an NR protocol stack used in a 5G NR system. Note that an LTE implementation of the protocol stack 200 may comprise similar structure to the NR protocol stack, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

Cell DTX (discontinuous transmission) and DRX (discontinuous reception) are mechanisms used in 3GPP cellular networks to save power and optimize the usage of network resources. For network energy savings, cell DTX may be used to reduce the power consumption of the base station (e.g., gNB) by turning off the transmitter when there is no user data to send. Similarly, cell DRX may be used to reduce the power consumption of the base station by entering a low power state where the receiver is partially or fully turned off for specific intervals, i.e., when no UL transmission are expected to be received from UEs.

Regarding cell DTX/DRX framework, the current 3GPP framework supports cell DTX/DRX operation via two modes: Mode 1 and Mode 2. In Mode 1, the network uses RRC configuration and activation of cell DTX/DRX, where the configuration and activation are separately signaled. In Mode 2, the network uses RRC configuration of cell DTX/DRX with L1 activation via PDCCH corresponding to DCI Format 2_9, which only corresponds to cell DTX/DRX, with no cell switch-off triggering included. However, a drawback of the conventional cell DTX/DRX framework is that no cell switch-off configuration and/or activation is included in legacy design.

Regarding conditional handover (CHO) procedure, in the case of a cell switch-off without indication to the UE, and in the presence of a set of candidate cells for conditional handover, the UE would switch to one of the candidate cells conditioned on the set of CHO metrics meeting a threshold value. However, a drawback of the conventional CHO procedure is that the handover is only pursued following a drop in a performance metric value beyond a threshold value, and not network-triggered due to an anticipated turning off of the cell.

Regarding radio link failure (RLF) procedure, in the case of a serving cell switch-off without indication to the UE, and in the absence of a set of candidate cells for CHO, an RLF procedure is performed to establish a connection with a new cell. However, a drawback of the conventional RLF procedure is that establishing a connection with a new cell following RLF incurs a large delay.

Regarding DRX for connected UEs, a UE's MAC entity may be configured by RRC with a DRX functionality that controls the UE's PDCCH monitoring activity for the MAC entity's cell radio network temporary identifier (C-RNTI), cancellation indication radio network temporary identifier (CI-RNTI), configured scheduling radio network temporary identifier (CS-RNTI), interruption/preemption radio network temporary identifier (INT-RNTI), slot format indicator radio network temporary identifier (SFI-RNTI), semi-persistent channel state information radio network temporary identifier (SP-CSI-RNTI), transmit power control physical uplink control channel radio network temporary identifier (TPC-PUCCH-RNTI), transmit power control physical uplink shared channel radio network temporary identifier (TPC-PUSCH-RNTI), transmit power control sounding reference signal radio network temporary identifier (TPC-SRS-RNTI), availability indication scheduling radio network temporary identifier (AI-RNTI), sidelink radio network temporary identifier (SL-RNTI), sidelink configured scheduled radio network temporary identifier (SLCS-RNTI), and sidelink (SL) semi-persistent scheduling variable radio network temporary identifier (V-RNTI).

When using DRX operation, the MAC entity shall also monitor PDCCH according to requirements found in other clauses of this specification. When in the RRC_CONNECTED state, if DRX is configured, for all the activated serving cells, the MAC entity may monitor the PDCCH discontinuously using the DRX operation. Otherwise, the MAC entity shall monitor the PDCCH (e.g., as specified in 3GPP technical specification (TS) 38.213).

The RRC controls DRX operation by configuring one or more of the following parameters: A) drx-onDurationTimer: the duration at the beginning of a DRX cycle; B) drx-SlotOffset: the delay before starting the drx-onDurationTimer; C) drx-InactivityTimer: the duration after the PDCCH occasion in which a PDCCH indicates a new UL, DL or SL transmission for the MAC entity; D) drx-RetransmissionTimerDL (per DL HARQ process except for the broadcast process): the maximum duration until a DL retransmission is received; E) drx-RetransmissionTimerUL (per UL HARQ process): the maximum duration until a grant for UL retransmission is received; F) drx-LongCycleStartOffset: the long DRX cycle and drx-StartOffset which defines the subframe where the long and short DRX cycle starts; G) drx-ShortCycle (optional): the short DRX cycle; H) drx-ShortCycleTimer (optional): the duration the UE shall follow the short DRX cycle; I) drx-HARQ-RTT-TimerDL (per DL HARQ process except for the broadcast process): the minimum duration before a DL assignment for HARQ retransmission is expected by the MAC entity; J) drx-HARQ-RTT-TimerUL (per UL HARQ process): the minimum duration before a UL HARQ retransmission grant is expected by the MAC entity; K) drx-RetransmissionTimerSL (per SL HARQ process): the maximum duration until a grant for SL retransmission is received; L) drx-HARQ-RTT-TimerSL (per SL HARQ process): the minimum duration before an SL retransmission grant is expected by the MAC entity; M) ps-Wakeup (optional): the configuration to start associated drx-onDurationTimer in case DCP is monitored but not detected; N) ps-TransmitOtherPeriodicCSI (optional): the configuration to report periodic channel state information (CSI) that is not L1-RSRP on physical uplink control channel (PUCCH) during the time duration indicated by drx-onDurationTimer in case DCP is configured but associated drx-onDurationTimer is not started; O) ps-TransmitPeriodicLI-RSRP (optional): the configuration to transmit periodic CSI that is L1-RSRP on PUCCH during the time duration indicated by drx-onDurationTimer in case DCP is configured but associated drx-onDurationTimer is not started; P) downlinkHARQ-FeedbackDisabled (optional): the configuration to disable HARQ feedback per DL HARQ process; Q) uplinkHARQ-Mode (optional): the configuration to set HARQmodeA or HARQmodeB per UL HARQ process; or a combination thereof.

Serving cells of a MAC entity may be configured by RRC in two DRX groups with separate DRX parameters. When RRC does not configure a secondary DRX group, there is only one DRX group and all serving cells belong to that one DRX group. When two DRX groups are configured, each serving cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, and drx-HARQ-RTT-TimerUL.

When DRX is configured, the active time for serving cells in a DRX group includes the time while: A) drx-onDurationTimer or drx-InactivityTimer configured for the DRX group is running; or B) drx-RetransmissionTimerDL, drx-RetransmissionTimerUL or drx-RetransmissionTimerSL is running on any serving cell in the DRX group; or C) ra-ContentionResolutionTimer or msgB-ResponseWindow is running; or D) a scheduling request (SR) is sent on PUCCH and is pending (if this serving cell is part of a non-terrestrial network, the active time is started after the SR transmission that is performed when the SR_COUNTER is 0 for all the SR configurations with pending SR(s) plus the UE-gNB round-trip time (RTT)); or E) a PDCCH indicating a new transmission addressed to the C-RNTI of the MAC entity has not been received after successful reception of a random access response for the random access preamble not selected by the MAC entity among the contention-based random access preamble.

The following MAC timers are used for DRX operation in a non-terrestrial network: A) HARQ-RTT-TimerDL-NTN (per DL hybrid automatic repeat request (HARQ) process configured with HARQ feedback enabled): the minimum duration before a DL assignment for HARQ retransmission is expected by the MAC entity; and B) HARQ-RTT-TimerUL-NTN (per UL HARQ process configured with HARQModeA): the minimum duration before a UL HARQ retransmission grant is expected by the MAC entity.

When DRX is not configured and multicast DRX is configured for a group radio network temporary identifier (G-RNTI) or group CS-RNTI (G-CS-RNTI), the MAC entity shall monitor the PDCCH (e.g., as specified in 3GPP TS 38.213). If a MAC PDU is received in a configured downlink assignment for unicast; or if the PDCCH indicates a DL unicast transmission, then the MAC entity stops the drx-RetransmissionTimerDL-PTM for the corresponding HARQ process.

When DRX is configured, if a MAC PDU is received in a configured downlink assignment for unicast, then if this serving cell is configured with downlinkHARQ-FeedbackDisabled, and if the corresponding HARQ process is configured with HARQ feedback enabled, the MAC entity shall set HARQ-RTT-TimerDL-NTN for the corresponding HARQ process equal to drx-HARQ-RTT-TimerDL plus the latest available UE-gNB RTT value and start the HARQ-RTT-TimerDL-NTN for the corresponding HARQ process in the first symbol after the end of the corresponding transmission carrying the DL HARQ feedback.

Else, if the MAC PDU is received in a configured downlink assignment for unicast, but this serving cell is not configured with downlinkHARQ-FeedbackDisabled, then the MAC entity shall start the drx-HARQ-RTT-TimerDL for the corresponding HARQ process in the first symbol after the end of the corresponding transmission carrying the DL HARQ feedback. When the MAC PDU is received in a configured downlink assignment for unicast, the MAC entity further stops the timer drx-RetransmissionTimerDL for the corresponding HARQ process and stop the timer drx-RetransmissionTimerDL-PTM for the corresponding HARQ process.

When DRX is configured, if a MAC PDU is transmitted in a configured uplink grant and LBT failure indication is not received from lower layers, then if this serving cell is configured with uplinkHARQ-Mode and if the corresponding HARQ process is configured as HARQModeA, then the MAC entity shall set HARQ-RTT-TimerUL-NTN for the corresponding HARQ process equal to drx-HARQ-RTT-TimerUL plus the latest available UE-gNB RTT value.

Further if drx-LastTransmissionUL is configured, then the MAC entity shall start the HARQ-RTT-TimerUL-NTN for the corresponding HARQ process in the first symbol after the end of the last transmission (within a bundle) of the corresponding PUSCH transmission. Else, if a MAC PDU is transmitted in a configured uplink grant and LBT failure indication is not received from lower layers, but the serving cell is not configured with uplinkHARQ-Mode, then if drx-LastTransmissionUL is not configured, the MAC entity shall start the timer HARQ-RTT-TimerUL-NTN for the corresponding HARQ process in the first symbol after the end of the first transmission (within a bundle) of the corresponding PUSCH transmission.

Otherwise, if a MAC PDU is transmitted in a configured uplink grant and LBT failure indication is not received from lower layers, but the serving cell is not configured with uplinkHARQ-Mode, then if drx-LastTransmissionUL is configured, the MAC entity starts the drx-HARQ-RTT-TimerUL for the corresponding HARQ process in the first symbol after the end of the last transmission (within a bundle) of the corresponding PUSCH transmission. However, if drx-LastTransmissionUL is not configured, then the MAC entity shall start the timer drx-HARQ-RTT-TimerUL for the corresponding HARQ process in the first symbol after the end of the first transmission (within a bundle) of the corresponding PUSCH transmission.

Moreover, when DRX is configured, and a MAC PDU is transmitted in a configured uplink grant, and LBT failure indication is not received from lower layers, then the MAC entity shall stop the drx-RetransmissionTimerUL for the corresponding HARQ process at the first transmission (within a bundle) of the corresponding PUSCH transmission.

When DRX is configured, if a MAC PDU is transmitted in a configured sidelink grant, then if the PUCCH resource is configured, the MAC entity shall start the drx-HARQ-RTT-TimerSL for the corresponding HARQ process in the first symbol after the end of the corresponding PUCCH transmission carrying the SL HARQ feedback; or start the for the corresponding HARQ process in the first symbol after the end of the corresponding PUCCH resource for the SL HARQ feedback when the PUCCH is not transmitted. The MAC entity shall further stop the drx-RetransmissionTimerSL for the corresponding HARQ process.

Else, when the PUCCH resource is not configured, then the MAC entity shall start the drx-HARQ-RTT-TimerSL for the corresponding HARQ process at the first symbol after the end of the corresponding PSSCH transmission, and shall stop the drx-RetransmissionTimerSL for the corresponding HARQ process.

When DRX is configured, if a drx-HARQ-RTT-TimerDL expires and if the data of the corresponding HARQ process was not successfully decoded, then the MAC entity shall start the drx-RetransmissionTimerDL for the corresponding HARQ process in the first symbol after the expiry of drx-HARQ-RTT-TimerDL.

When DRX is configured, if a HARQ-RTT-TimerDL-NTN expires and if the data of the corresponding HARQ process was not successfully decoded, then the MAC entity shall start the drx-RetransmissionTimerDL for the corresponding HARQ process in the first symbol after the expiry of HARQ-RTT-TimerDL-NTN.

When DRX is configured, if a drx-HARQ-RTT-TimerUL expires, then the MAC entity shall start the drx-RetransmissionTimerUL for the corresponding HARQ process in the first symbol after the expiry of drx-HARQ-RTT-TimerUL.

When DRX is configured, if a HARQ-RTT-TimerUL-NTN expires, then the MAC entity shall start the drx-RetransmissionTimerUL for the corresponding HARQ process in the first symbol after the expiry of HARQ-RTT-TimerUL-NTN.

When DRX is configured, if a drx-HARQ-RTT-TimerSL expires, then if a HARQ NACK feedback for the corresponding HARQ process is transmitted on PUCCH, or if a HARQ NACK feedback for the corresponding HARQ process is generated but not transmitted on PUCCH, or if the PUCCH resource is not configured for the SL grant, then the MAC entity shall start the drx-RetransmissionTimerSL for the corresponding HARQ process in the first symbol after the expiry of drx-HARQ-RTT-TimerSL. Note that the UE handles the drx-RetransmissionTimerSL operation when sl-PUCCH-Config is configured by RRC, but PUCCH resource is not scheduled same as when sl-PUCCH-Config is not configured.

When DRX is configured, if a DRX command MAC CE indicated by PDCCH addressed to C-RNTI or CS-RNTI, or by a configured downlink assignment for unicast transmission or a long DRX command MAC CE is received, then the MAC entity shall stop drx-onDurationTimer for each DRX group; and shall stop drx-InactivityTimer for each DRX group.

When DRX is configured, if drx-InactivityTimer for a DRX group expires, then if the short DRX cycle is configured, the MAC entity shall start or restart drx-ShortCycleTimer for this DRX group in the first symbol after the expiry of drx-InactivityTimer, and shall use the short DRX cycle for this DRX group. Else, if drx-InactivityTimer for a DRX group expires, but the short DRX cycle is not configured, then the MAC entity shall use the long DRX cycle for this DRX group.

When DRX is configured, if a DRX command MAC CE indicated by PDCCH addressed to C-RNTI or CS-RNTI, or by a configured downlink assignment for unicast transmission is received, then if the short DRX cycle is configured, the MAC entity shall start or restart drx-ShortCycleTimer for each DRX group in the first symbol after the end of DRX command MAC CE reception; and shall use the short DRX cycle for each DRX group. Else, if the DRX command MAC CE indicated by PDCCH addressed to C-RNTI or CS-RNTI, or by a configured downlink assignment for unicast transmission is received, but the short DRX cycle is not configured, the MAC entity shall use the long DRX cycle for each DRX group.

When DRX is configured, if drx-ShortCycleTimer for a DRX group expires, then the MAC entity shall use the long DRX cycle for this DRX group.

When DRX is configured, if a long DRX command MAC CE is received, then the MAC entity shall stop drx-ShortCycleTimer for each DRX group; and shall use the long DRX cycle for each DRX group.

When DRX is configured, if the short DRX cycle is used for a DRX group, and [(SFN××10)+subframe number] modulo (drx-ShortCycle)=(drx-StartOffset) modulo (drx-ShortCycle), then the MAC entity shall start drx-onDurationTimer for this DRX group after drx-SlotOffset from the beginning of the subframe.

When DRX is configured, if the long DRX cycle is used for a DRX group, and [(SFN×10)+subframe number] modulo (drx-LongCycle)=drx-StartOffset, then if DCP monitoring is configured for the active DL BWP (e.g., as specified in 3GPP TS 38.213), and if either A) DCP indication associated with the current DRX cycle received from lower layer indicated to start drx-onDurationTimer (e.g., as specified in 3GPP TS 38.213); or B) all DCP occasion(s) in time domain, as specified in 3GPP TS 38.213, associated with the current DRX cycle occurred in active time considering grants/assignments/DRX command MAC CE/long DRX command MAC CE received and scheduling request sent until 4 ms prior to start of the last DCP occasion, or during a measurement gap, or when the MAC entity monitors for a PDCCH transmission on the search space indicated by recoverySearchSpaceId of the special cell (SpCell) identified by the C-RNTI while the ra-ResponseWindow is running; or C) ps-Wakeup is configured with value true and DCP indication associated with the current DRX cycle has not been received from lower layers, the MAC entity shall start drx-onDurationTimer after drx-SlotOffset from the beginning of the subframe.

Else, if the long DRX cycle is used for a DRX group, and [(SFN×10)+subframe number] modulo (drx-LongCycle)=drx-StartOffset, but DCP monitoring is not configured for the active DL BWP, then the MAC entity shall start drx-onDurationTimer for this DRX group after drx-SlotOffset from the beginning of the subframe. Note that for the case of unaligned SFN across carriers in a cell group, the SFN of the SpCell is used to calculate the DRX duration.

When DRX is configured, if a DRX group is in active time, then the MAC entity shall monitor the PDCCH on the serving cells in this DRX group as specified in 3GPP TS 38.213. If the PDCCH indicates a DL transmission; or if the PDCCH indicates a one-shot HARQ feedback (e.g., as specified in 3GPP TS 38.213); or if the PDCCH indicates a retransmission of HARQ feedback (e.g., as specified in 3GPP TS 38.213), then if this serving cell is configured with downlinkHARQ-FeedbackDisabled and if the corresponding HARQ process is configured with HARQ feedback enabled, then the MAC entity shall set HARQ-RTT-TimerDL-NTN for the corresponding HARQ process equal to drx-HARQ-RTT-TimerDL plus the latest available UE-gNB RTT value; and shall start the HARQ-RTT-TimerDL-NTN for the corresponding HARQ process in the first symbol after the end of the corresponding transmission carrying the DL HARQ feedback.

However, for the above condition, if the serving cell is not configured with downlinkHARQ-FeedbackDisabled, then the MAC entity shall start or restart the drx-HARQ-RTT-TimerDL for the corresponding HARQ process(es) whose HARQ feedback is reported in the first symbol after the end of the corresponding transmission carrying the DL HARQ feedback. Note that when HARQ feedback is postponed by PDSCH-to-HARQ_feedback timing indicating an inapplicable k1 value (e.g., as specified in 3GPP TS 38.213), the corresponding transmission opportunity to send the DL HARQ feedback is indicated in a later PDCCH requesting the HARQ-ACK feedback. As used herein, HARQ-ACK may represent collectively the positive acknowledgement (ACK) and the negative acknowledgement (NACK) and DTX. ACK means that a transport block (TB) is correctly received while NACK (or NAK) means a TB is erroneously received and DTX means that no TB was detected.

When DRX is configured, if a DRX group is in active time, then the MAC entity shall monitor the PDCCH on the serving cells in this DRX group as specified in 3GPP TS 38.213. If the PDCCH indicates a DL transmission; or if the PDCCH indicates a one-shot HARQ feedback (e.g., as specified in 3GPP TS 38.213); or if the PDCCH indicates a retransmission of HARQ feedback (e.g., as specified in 3GPP TS 38.213), then the MAC entity shall stop the drx-RetransmissionTimerDL for the corresponding HARQ process(es) whose HARQ feedback is reported; and shall stop the drx-RetransmissionTimerDL-PTM for the corresponding HARQ process. If the PDSCH-to-HARQ_feedback timing indicates an inapplicable k1 value (e.g., as specified in 3GPP TS 38.213), then the MAC entity shall start the drx-RetransmissionTimerDL in the first symbol after the (end of the last) PDSCH transmission (within a bundle) for the corresponding HARQ process.

Additionally, when the DRX group is in active time, if the PDCCH indicates a UL transmission, and if this serving cell is configured with uplinkHARQ-Mode, and if the corresponding HARQ process is configured as HARQModeA, then the MAC entity shall set HARQ-RTT-TimerUL-NTN for the corresponding HARQ process equal to drx-HARQ-RTT-TimerUL plus the latest available UE-gNB RTT value. Further if drx-LastTransmissionUL is configured, then the MAC entity shall start the HARQ-RTT-TimerUL-NTN for the corresponding HARQ process in the first symbol after the end of the last transmission (within a bundle) of the corresponding PUSCH transmission. Else, the MAC entity shall start the HARQ-RTT-TimerUL-NTN for the corresponding HARQ process in the first symbol after the end of the first transmission (within a bundle) of the corresponding PUSCH transmission.

Otherwise, if the PDCCH indicates a UL transmission, but the serving cell is not configured with uplinkHARQ-Mode, then if drx-LastTransmissionUL is configured, then the MAC entity shall start the drx-HARQ-RTT-TimerUL for the corresponding HARQ process in the first symbol after the end of the last transmission (within a bundle) of the corresponding PUSCH transmission, else the MAC entity shall start the drx-HARQ-RTT-TimerUL for the corresponding HARQ process in the first symbol after the end of the first transmission (within a bundle) of the corresponding PUSCH transmission. Further, when the PDCCH indicates a UL transmission, the MAC entity shall stop the drx-RetransmissionTimerUL for the corresponding HARQ process.

Additionally, when the DRX group is in active time, if the PDCCH indicates an SL transmission, if the PUCCH resource is configured, then the MAC entity shall start the drx-HARQ-RTT-TimerSL for the corresponding HARQ process in the first symbol after the end of the corresponding PUCCH transmission carrying the SL HARQ feedback; or shall start the drx-HARQ-RTT-TimerSL for the corresponding HARQ process in the first symbol after the end of the corresponding PUCCH resource for the SL HARQ feedback when the PUCCH is not transmitted. The MAC entity further shall stop the drx-RetransmissionTimerSL for the corresponding HARQ process. Otherwise, if the PDCCH indicates a SL transmission, but the PUCCH resource is not configured, the MAC entity shall start the drx-HARQ-RTT-TimerSL for the corresponding HARQ process at the first symbol after end of PDCCH occasion; and shall stop the drx-RetransmissionTimerSL for the corresponding HARQ process.

Additionally, when the DRX group is in active time, if the PDCCH indicates a new transmission (DL, UL or SL) on a serving cell in this DRX group, then the MAC entity shall start or restart drx-InactivityTimer for this DRX group in the first symbol after the end of the PDCCH reception. Note that a PDCCH indicating activation of SPS, configured grant type 2, or configured sidelink grant of configured grant Type 2 is considered to indicate a new transmission. Further note that if the PDCCH reception includes two PDCCH candidates from corresponding search spaces (e.g., as described in clause 10.1 in 3GPP TS 38.213), the MAC entity shall start or restart drx-InactivityTimer for this DRX group in the first symbol after the end of the PDCCH candidate that ends later in time.

Additionally, when the DRX group is in active time, if a HARQ process receives downlink feedback information and acknowledgement is indicated, then the MAC entity shall stop the drx-RetransmissionTimerUL for the corresponding HARQ process.

When DRX is configured, if downlink control information of power saving (DCP) monitoring is configured for the active DL BWP (e.g., as specified in 3GPP TS 38.213); and if the current symbol n occurs within drx-onDurationTimer duration; and if drx-onDurationTimer associated with the current DRX cycle is not started, then if the MAC entity would not be in active time considering grants/assignments/DRX command MAC CE/long DRX command MAC CE received and scheduling request sent until 4 ms prior to symbol n when evaluating all DRX active time conditions as specified in this clause; and if allowCSI-SRS-Tx-MulticastDRX-Active is not configured or, if all multicast DRXes would not be in active time considering multicast assignments/DRX command MAC CE for multicast-broadcast services (MBS) multicast received until 4 ms prior to symbol n when evaluating all DRX active time conditions and all multicast sessions are configured with multicast DRX, then the MAC entity shall not transmit periodic SRS and semi-persistent SRS (e.g., defined in 3GPP TS 38.214); and shall not report semi-persistent CSI configured on PUSCH; and if ps-TransmitPeriodicLI-RSRP is not configured with value true, the MAC entity shall not report periodic CSI that is L1-RSRP on PUCCH; and if ps-TransmitOtherPeriodicCSI is not configured with value true, the MAC entity shall not report periodic CSI that is not L1-RSRP on PUCCH.

When DRX is configured, but none of the above conditions apply, then in current symbol n, if a DRX group would not be in active time considering grants/assignments scheduled on serving cell(s) in this DRX group and DRX command MAC CE/long DRX command MAC CE received and scheduling request sent until 4 ms prior to symbol n when evaluating all DRX active time conditions as specified in this clause; and if allowCSI-SRS-Tx-MulticastDRX-Active is not configured or, in current symbol n, if all multicast DRXes corresponding to the DRX group would not be in active time considering multicast assignments/DRX command MAC CE for MBS multicast received until 4 ms prior to symbol n when evaluating all DRX active time conditions and all multicast sessions corresponding to the DRX group are configured with multicast DRX, then the MAC entity shall not transmit periodic SRS and semi-persistent SRS defined in 3GPP TS 38.214 in this DRX group; and shall not report CSI on PUCCH and semi-persistent CSI configured on PUSCH in this DRX group.

However, if CSI masking (csi-Mask) is setup by upper layers, then in current symbol n, if drx-onDurationTimer of a DRX group would not be running considering grants/assignments scheduled on serving cell(s) in this DRX group and DRX command MAC CE/long DRX command MAC CE received until 4 ms prior to symbol n when evaluating all DRX active time conditions as specified in this clause; and if allowCSI-SRS-Tx-MulticastDRX-Active is not configured or, in current symbol n, if drx-onDurationTimerPTM(s) of all multicast DRXes corresponding to the DRX group would not be running considering DRX command MAC CE for MBS multicast received until 4 ms prior to symbol n when evaluating all DRX active time conditions and all multicast sessions corresponding to the DRX group are configured with multicast DRX, then the MAC entity shall not report CSI on PUCCH in this DRX group.

Note that if a UE multiplexes a CSI configured on PUCCH with other overlapping UCI(s) according to the procedure (e.g., as specified in 3GPP TS 38.213) and this CSI multiplexed with other UCI(s) would be reported on a PUCCH resource either outside DRX active time of the DRX group in which this PUCCH is configured or outside the on-duration period of the DRX group in which this PUCCH is configured if CSI masking is setup by upper layers, it is up to UE implementation whether to report this CSI multiplexed with other UCI(s).

Regardless of whether the MAC entity is monitoring PDCCH or not on the serving cells in a DRX group, the MAC entity transmits HARQ feedback, aperiodic CSI on PUSCH, and aperiodic SRS (e.g., as defined in 3GPP TS 38.214) on the serving cells in the DRX group when such is expected.

The MAC entity need not monitor the PDCCH if it is not a complete PDCCH occasion (e.g., the active time starts or ends in the middle of a PDCCH occasion).

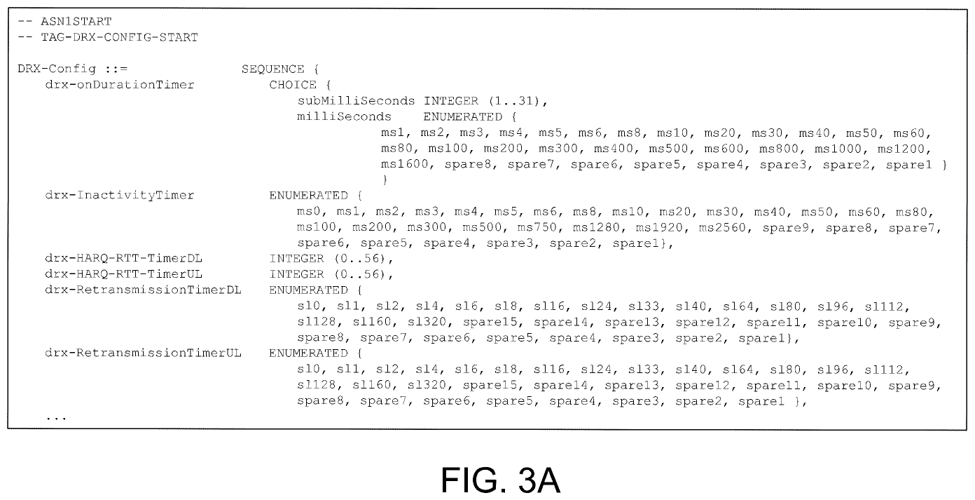

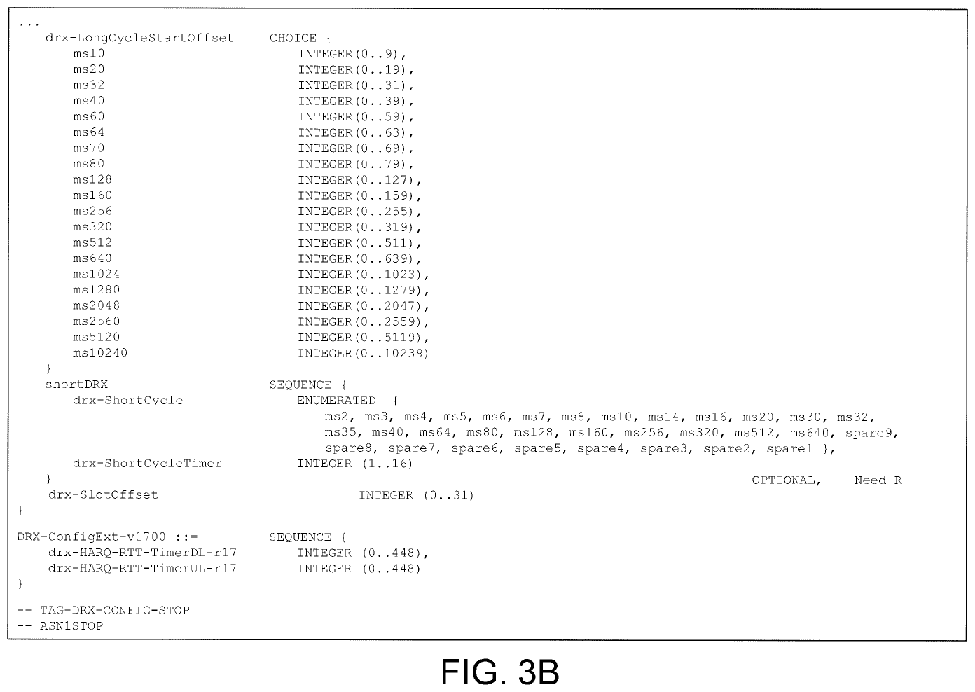

FIGS. 3A-3B illustrate an exemplary DRX configuration IE, in accordance with aspects of the present disclosure. A description of the fields of the DRX configuration IE is found in Table 1, below.

TABLE 1
DRX-Config IE field descriptions
DRX-Config field descriptions

drx-HARQ-RTT-TimerDL
Value in number of symbols of the BWP where the transport block was received. drx-HARQ-RTT-
TimerDL-r17 is only applicable for SCS 480 kHz and 960 kHz. If configured, the UE shall
ignore drx-HARQ-RTT-TimerDL (without suffix) for SCS 480 kHz and 960 kHz.
drx-HARQ-RTT-TimerUL
Value in number of symbols of the BWP where the transport block was transmitted. drx-HARQ-RTT-
TimerUL-r17 is only applicable for SCS 480 kHz and 960 kHz. If configured, the UE shall
ignore drx-HARQ-RTT-TimerUL (without suffix) for SCS 480 kHz and 960 kHz.
drx-InactivityTimer
Value in multiple integers of 1 ms. ms0 corresponds to 0, ms1 corresponds to 1 ms, ms2 corresponds to
2 ms, and so on.
drx-LongCycleStartOffset
drx-LongCycle in ms and drx-StartOffset in multiples of 1 ms. If drx-ShortCycle is configured, the
value of drx-LongCycle shall be a multiple of the drx-ShortCycle value.
drx-onDurationTimer
Value in multiples of 1/32 ms (subMilliSeconds) or in ms (milliSecond). For the latter, value ms1
corresponds to 1 ms, value ms2 corresponds to 2 ms, and so on.
drx-RetransmissionTimerDL
Value in number of slot lengths of the BWP where the transport block was received. Value sl0
corresponds to 0 slots, sl1 corresponds to 1 slot, sl2 corresponds to 2 slots, and so on.
drx-RetransmissionTimerUL
Value in number of slot lengths of the BWP where the transport block was transmitted. Value sl0
corresponds to 0 slots, sl1 corresponds to 1 slot, sl2 corresponds to 2 slots, and so on.
drx-ShortCycleTimer
Value in multiples of drx-ShortCycle. A value of 1 corresponds to drx-ShortCycle, a value of 2
corresponds to 2 * drx-ShortCycle and so on.
drx-ShortCycle
Value in ms. ms1 corresponds to 1 ms, ms2 corresponds to 2 ms, and so on.
drx-SlotOffset
Value in 1/32 ms. Value 0 corresponds to 0 ms, value 1 corresponds to 1/32 ms, value 2 corresponds to
2/32 ms, and so on.

Regarding Rel-18 based cell DTX/DRX, the following signals/channels are expected to be impacted, e.g., either by UE not monitoring reception for DL signals/channels or not transmitting for UL signals/channels, by cell DTX/DRX, respectively, as follows:

In certain embodiments, the UE does not monitor SPS occasions during cell DTX non-active period, e.g., gNB is assumed to not transmit PDSCH to that UE on such SPS occasions during the cell DTX non-active periods. In certain embodiments, the UE does not transmit on configured grant (CG) occasions during cell DRX non-active periods. In certain embodiments, the UE does not transmit SR occasions overlapping with cell DRX non-active periods, e.g., SR transmissions are dropped during the cell DRX non-active periods.

The UE does not expect to receive and/or process periodic/semi-persistent channel state information reference signal (CSI-RS) configured in CSI report configuration in CSI-ReportConfig with reportQuantity including RI (for CSI reporting), during non-active periods of cell DTX. The UE does not expect to transmit periodic/semi-persistent CSI reports during non-active periods of cell DRX.

The UE does not expect to transmit periodic/semi-persistent SRS during non-active periods of cell DRX, except when the SRS is for positioning. The UE does not expect to monitor PDCCHs associated with DCI format 2_0-DCI Format 2_5, during non-active periods of cell DTX.

On the other hand, the following signals/channels are not expected to be impacted by cell DTX/DRX, as follows:

No impact to RACH, paging, and SIBs in idle/inactive for both the gNB and Rel-18 and legacy UEs. The UE monitors PDCCH for RAR during cell DTX non-active time. The ra-ResponseWindow could be started as legacy. The UE monitors PDCCH for RACH message 4 (Msg4) during cell DTX non-active time. The ra-ContentionResolutionTimer could be started as legacy.

Once the gNB recognizes there is an emergency call or public safety related service (e.g., MPS/MCS), the network ensures there is no impact to the emergency call (e.g., may deactivate cell DTX/DRX). When a dynamic grant (DG) is received, by the gNB during cell DRX/DTX, the UE follows the grant assignment (i.e., like in legacy). This includes DL HARQ feedback.

The HARQ-ACK of SPS PDSCH transmitted is not impacted by non-active period of cell DRX. SRS for positioning is not impacted by cell DRX operation. HARQ-ACK of a DCI format without scheduling a PDSCH is not impacted by non-active period of cell DRX.

For the supported cell DTX/DRX pattern, the following has been agreed:

Pattern configuration for cell DRX/DTX is common for Rel-18 UEs in the cell. Separate DTX and DRX configuration are supported, i.e., cell DTX can be configured without cell DRX. A periodic cell DTX/DRX configuration is explicitly signaled to the UEs.

A periodic cell DTX/DRX pattern is configured by UE specific RRC signaling. The cell DTX/DRX configuration contains at least: periodicity, start slot/offset, on duration. In certain embodiments, cell DTX/DRX is activated/deactivated implicitly by RRC signaling, i.e., activated immediately once configured by RRC and deactivated once the RRC configuration is released.

The start timer formula of the onDurationTimer from UE C-DRX (including SlotOffset) are to be reused to specify the start of cellDTX-onDurationTimer (and cellDRX-onDurationTimer) in 3GPP TS 38.321, which are expected to have the same value range as UE C-DRX long cycle. On-duration and cycle parameters are common between cell DTX and DRX, when both are configured.

If C-DRX is configured and the retransmission timer is running, the UE is expected to monitor PDCCH, like in legacy. It is up to the network whether it schedules retransmissions out of the cell DTX active period, i.e., when the DRX retransmission timer is running, the UE should monitor PDCCH regardless of the cell DTX. The network ensures there is at least partial overlapping between UE C-DRX on-duration and cell DTX/DRX on-duration, e.g., via configuring the cell DTX/DRX and C-DRX periodicity to be a multiple of each other.

It was also agreed to support Layer-1 (L1) signaling for activation and deactivation of cell DTX/DRX. More specifically, the following has been agreed:

Pattern configuration for cell DRX/DTX is common for Rel-18 UEs in the cell. The group common L1 signaling using PDCCH for cell DTX/DRX activation and deactivation is based on a new DCI format 2_X, which is monitored in the common search space.

DCI format 2_X at least includes N information block field(s), each containing signaling of activation or deactivation of ‘a configuration of cell DTX and/or DRX’ of ‘a serving cell’. The DCI may also include spare/reserved padding bits to match the size configured for DCI 2_X, if needed. For a serving cell configured with supplementary uplink (SUL), the same bit is applicable for both non-supplemental (i.e., normal) uplink (NUL) and SUL.

For each serving cell configured with L1 signaling based activation/deactivation of cell DTX and/or cell DRX configuration, starting bit position of an information block of DCI format 2_X is provided by UE specific higher layer signaling.

An information block field of DCI format 2_X for activation and deactivation of cell DTX and DRX configuration supports separate (activation/deactivation) signaling for cell DTX and cell DRX, i.e., one activation/deactivation signaling sub-field for cell DTX configuration and one activation/deactivation signaling sub-field for cell DRX configuration, i.e., separate 1 bit indication for each of activation/deactivation for one cell DTX and one cell DRX.

An information block field of DCI format 2_X is variable size either 1 or 2 bits, based on whether higher layer signaling configures one or both cell DTX and cell DRX for a given serving cell. If both are configured, the first bit corresponds to activation/deactivation of cell DTX configuration, and the second bit corresponds to activation/deactivation of cell DRX configuration. Otherwise, the 1 bit corresponds to the configured cell DTX or cell DRX configuration.

DCI format 2_X supports activation/deactivation of cell DTX/DRX configuration of multiple serving cells and supports activation/deactivation per cell, wherein a UE monitors DCI format 2_X in one serving cell. A new RNTI, e.g., nes-RNTI, which is configured by higher layer, for scrambling of DCI format 2_X.

Both the search space set configuration with new DCI format 2_X and the DCI size for DCI format 2_X are to be included in the RRC parameter list for new DCI format 2_X for activation and deactivation of cell DTX/DRX.

A delay value (D) that is applied after DCI Format 2_X reception that activates/deactivates cell DTX/DRX configuration is defined, where the UE is expected to apply cell DTX or DRX activation/deactivation change at beginning of the slot k where the SCS of slot X is with respect to the active DL or UL BWP of the serving cell, respectively. Slot k is the first slot whose beginning is no earlier than the beginning of slot n+D, where n is the slot containing the PDCCH of DCI format 2_X based on SCS of PDCCH, where the possible values of D with respect to SCS are provided in Table 2.

TABLE 2
Values of D with respect to SCS

| SCS of PDCCH (kHz) | D (in slots) |
|---|---|
| 15 | 3 |
| 30 | 6 |
| 60 | 12 |
| 120 | 24 |
| 480 | 96 |
| 960 | 192 |

For the following solutions, one or more of the following assumptions may be held.

Unless otherwise stated, transmission and reception are assumed from a network perspective, i.e., transmission refers to network transmission and reception refers to network reception.

Unless otherwise stated, the following notions are used interchangeably: network nodes, transmit-receive point (TRP), panel, set of antennas, set of antenna ports, uniform linear array, cell, node, radio head, communication (e.g., signals/channels) associated with a control resource set (CORESET) pool, communication associated with a transmission configuration indicator (TCI) state from a transmission configuration comprising at least two TCI states.

As used herein, a matrix implies a sequence of fields of an arbitrary dimension, including an array (vector) of values, a standard 2D matrix and more generally a Q-dimensional matrix (tensor) wherein Q>2 is an integer value.

Several implementations are described below. According to a possible implementation, one or more elements or features from one or more of the described implementations may be combined.

According to aspects of the first solution, the enhanced cell DTX/DRX configuration enables an enhanced PDCCH with DCI format that supports joint L1 triggering of cell DTX/DRX, and cell turn-off, where the DCI fields included in the PDCCH transmission are based on at least a higher-layer configuration of cell DTX/DRX, and a higher-layer configuration of cell turning off being either enabled or disabled.

In a first implementation, cell turn-off is referred by at least one of: A) cell switch-off; B) cell handover; C) conditional handover (CHO); D) cell sleep; E) cell deactivation; F) cell disabling; G) handover command; H) handover trigger; I) cell offload; J) energy saving (e.g., NES-specific) CHO execution condition; or K) a combination thereof. An example of the CHO is the energy saving (e.g., NES-specific) CHO.

In a second implementation of the first solution, the cell turn-off indication is included in PDCCH corresponding to DCI Format 2_9 conditioned on a higher-layer parameter, e.g., cellTurnOffConfig, cellTurnOff, nes-CondHandover, wherein the DCI field corresponding to cell turn-off is included only if the higher-layer parameter corresponding to cell turn-off is configured.

In a first example of this second implementation, the higher-layer parameter for cell turn-off is included as part of an RRC configuration information element for cell turn-off configuration, handover, conditional handover, or a combination thereof. In a second example, the higher-layer parameter for cell turn-off is included as part of the cell DTX/DRX configuration.

The cell DTX/DRX configuration IE (e.g., CellDTXDRX-Config IE) is used to configure cell DTX/DRX related parameters. Cell DTX is configured only when C-DRX is configured.

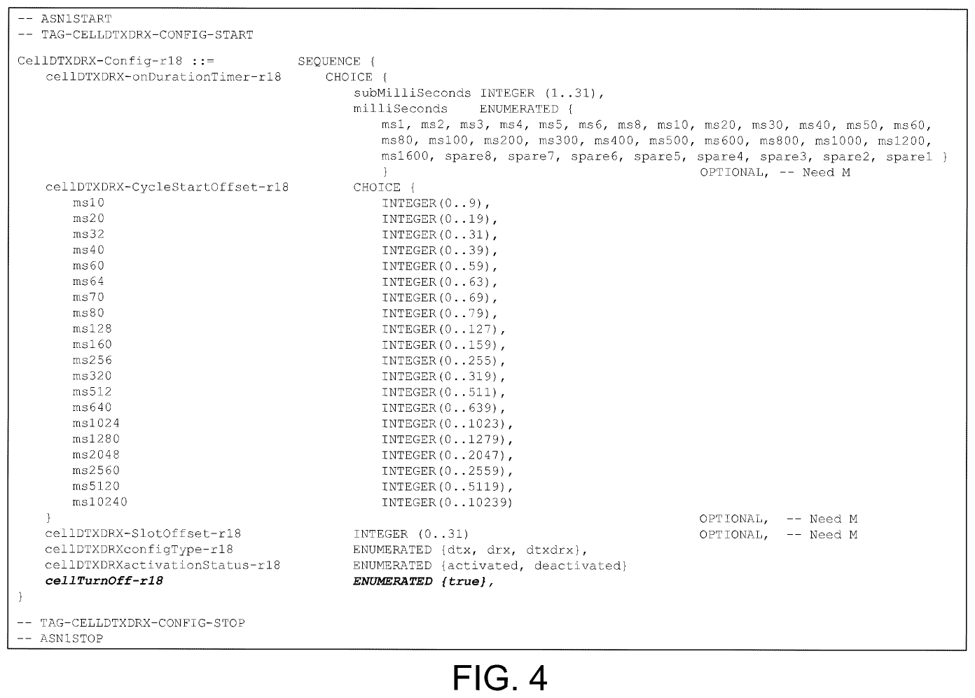

FIG. 4 illustrates an exemplary cell DTX/DRX configuration IE, in accordance with aspects of the present disclosure. The cell DTX/DRX configuration is a set of parameters that defines how and when the UE should enter or exit low-power states, as well as how often it should monitor the network for incoming data. A description of the fields of the cell DTX/DRX configuration IE is found in Table 3, below.

TABLE 3
CellDTXDRX-Config IE field descriptions
CellDTXDRX-Config field descriptions

cellDTXDRX-CycleStartOffset
cellDTXDRX-Cycle in ms and cellDTXDRX-StartOffset in multiples of 1 ms.
The configured cellDTXDRX-Cycle is an integer multiple of configured drx-longCycle or vice versa.
If this field is absent, the UE shall apply the stored value of this parameter.
cellDTXDRX-onDurationTimer
Value in multiples of 1/32 ms (subMilliSeconds) or in ms (milliSecond). For the latter, value ms1
corresponds to 1 ms, value ms2 corresponds to 2 ms, and so on.
If this field is absent, the UE shall apply the stored value of this parameter.
cellDTXDRX-SlotOffset
Value in 1/32 ms. Value 0 corresponds to 0 ms, value 1 corresponds to 1/32 ms, value 2 corresponds
to 2/32 ms, and so on.
If this field is absent, the UE shall apply the stored value of this parameter.
cellDTXDRXactivationStatus
Initial activation status of cell DTX/DRX indicating whether the UE shall activate the configuration
according to the received parameters.
cellDTXDRXconfigType
Indicates whether the configuration is for cell DTX only, cell DRX only, or joint cell DTX/DRX
configuration. If set to ‘dtxdrx’, the UE shall apply a joint cell DTX and DRX configuration
with the same parameters as in CellDTXDRX-Config.
cellTurnOff
Indicates whether cell turn-off is configured

In a third implementation of the first solution, the UE is not expected to transmit or receive signals and channels from a cell after a given time of receiving an indication of activating or enabling the cell turn-off.

According to aspects of the second solution, the enhanced cell DTX/DRX configuration enables a priority rule for applicability of a cell turn-off indicator over a cell DTX/DRX indicator in the DCI, wherein the cell turn-off indicator overrides the cell DTX/DRX indicator, if the cell turning off is triggered.

A first implementation of the second solution corresponds to DCI format 2_9 where both cell DTX/DRX and cell turn-off are higher layer configured, with cell turn-off associated with a lower priority (e.g., LSB bit in the block). If the UE is configured with higher layer parameter CellDTXDRX-Config, one or more blocks are configured for the UE by higher layers, with the following fields are defined for each block:

A 1-bit field providing cell DTX/DRX indication if the higher layer parameter cellDTXDRXconfigType is configured to ‘dtx’ or ‘drx’ and higher layer parameter cellTurnOff is not configured;
A 1-bit field providing cell turn-off indication if the higher layer parameter cellDTXDRXconfigType is not configured and higher layer parameter cellTurnOff is configured;
A 2-bit field providing cell DTX/DRX indication if cellDTXDRXconfigType is configured to ‘dtxdrx’ and higher layer parameter cellTurnOff is not configured, with the MSB corresponding to cell DTX configuration and the LSB corresponding to cell DRX configuration;
A 2-bit field providing cell DTX/DRX indication if cellDTXDRXconfigType is configured to ‘dtx’ or ‘drx’ and higher layer parameter cellTurnOff is configured, with the MSB corresponding to cell DTX/DRX configuration and the LSB corresponding to cell turn-off indication;
A 3-bit field if cellDTXDRXconfigType is configured to ‘dtxdrx’ and higher layer parameter cellTurnOff is configured, with the 2 most significant bits (MSB) providing cell DTX/DRX indication with the MSB corresponding to cell DTX configuration and the LSB corresponding to cell DRX configuration and the 1 least significant bit (LSB) providing cell turn-off indication.

In the first implementation, the size of DCI format 2_9 is indicated by the higher layer parameter sizeDCI-2-9.

A second implementation of the second solution corresponds to DCI format 2_9 where both cell DTX/DRX and cell turn-off are higher layer configured, with cell turn-off associated with a higher priority (e.g., MSB bit in the block). If the UE is configured with higher layer parameter CellDTXDRX-Config, one or more blocks are configured for the UE by higher layers, with the following field defined for each block:

A 1-bit field providing cell DTX/DRX indication if the higher layer parameter cellDTXDRXconfigType is configured to ‘dtx’ or ‘drx’ and higher layer parameter cellTurnOff is not configured;

A 1-bit field providing cell turn-off indication if the higher layer parameter cellDTXDRXconfigType is not configured and higher layer parameter cellTurnOff is configured;

A 2-bit field providing cell DTX/DRX indication if cellDTXDRXconfigType is configured to ‘dtxdrx’ and higher layer parameter cellTurnOff is not configured, with the MSB corresponding to cell DTX configuration and the LSB corresponding to cell DRX configuration;

A 2-bit field providing cell DTX/DRX indication if cellDTXDRXconfigType is configured to ‘dtx’ or ‘drx’ and higher layer parameter cellTurnOff is configured, with the MSB corresponding to cell turn-off indication and the LSB corresponding to cell DTX/DRX configuration;

A 3-bit field if cellDTXDRXconfigType is configured to ‘dtxdrx’ and higher layer parameter cellTurnOff is configured, with 1 MSB providing cell turn-off indication and the 2 remaining bits (i.e., LSB) providing Cell DTX/DRX indication, wherein the MSB of the 2 remaining bits corresponds to cell DTX configuration and the LSB of the 2 remaining bits corresponds to cell DRX configuration.

In the second implementation, the size of DCI format 2_9 is indicated by the higher layer parameter sizeDCI-2-9.

In some implementations, for a UE supporting NES (or a UE capable of NES), cell turn-off indication (or Energy saving (e.g., NES-specific) CHO execution condition indication) is supported (e.g., signaling included in DCI format 2_9) and cell turn-off has no higher-layer configuration. In some implementations, cell turn-off indication is supported, and cell turn-off has no higher-layer configuration for a UE supporting NES and if at least one of the events associated to the measIds within condTriggerConfig for a target candidate cell within condRRCReconfig is configured with nesEvent.

A third implementation of the second solution corresponds to DCI format 2_9 where cell turn-off has no higher-layer configuration, with cell turn-off associated with a lower priority. If the UE is configured with higher layer parameter CellDTXDRX-Config, one or more blocks are configured for the UE by higher layers, with the following field defined for each block:
A 1-bit field providing cell turn-off indication if the higher layer parameter cellDTXDRXconfigType is not configured;
A 2-bit field providing cell DTX/DRX indication if cellDTXDRXconfigType is configured to ‘dtx’ or ‘drx’, with the MSB corresponding to cell DTX/DRX configuration and the LSB corresponding to cell turn-off indication;
A 3-bit field if cellDTXDRXconfigType is configured to ‘dtxdrx’, with the 2 MSB bits providing cell DTX/DRX indication with the MSB corresponding to cell DTX configuration and the LSB corresponding to cell DRX configuration, and the LSB providing cell turn-off indication.

In the third implementation, the size of DCI format 2_9 is indicated by the higher layer parameter sizeDCI-2-9.

A fourth implementation of the second solution corresponds to DCI format 2_9 where cell turn-off has no higher-layer configuration, with cell turn-off associated with a higher priority. If the UE is configured with higher layer parameter CellDTXDRX-Config, one or more blocks are configured for the UE by higher layers, with the following field defined for each block:
A 1-bit field providing cell turn-off indication if the higher layer parameter cellDTXDRXconfigType is not configured;
A 2-bit field providing cell DTX/DRX indication if cellDTXDRXconfigType is configured to ‘dtx’ or ‘drx’, with the MSB corresponding to cell turn-off indication and the LSB corresponding to cell DTX/DRX configuration;
A 3-bit field if cellDTXDRXconfigType is configured to ‘dtxdrx’, with the MSB providing cell turn-off indication; and the 2 remaining (LSB) bits providing cell DTX/DRX indication, wherein the MSB of the 2 remaining bits corresponds to cell DTX configuration and the LSB of the 2 remaining bits corresponds to cell DRX configuration;
In the fourth implementation, the size of DCI format 2_9 is indicated by the higher layer parameter sizeDCI-2-9.

In a fifth implementation of the second solution, if the DCI field bit corresponding to cell turn-off is set to one (‘1’) or enabled, then the UE is expected to ignore the value of the DCI fields corresponding to cell DTX and/or cell DRX, if applicable. In some implementations, if the DCI field bit corresponding to cell turn-off is set to one (‘1’) or enabled or activated, the UE is not expected to receive the value of the DCI fields corresponding to cell DTX and/or cell DRX, if applicable to be set to ‘1’ or enabled or activated. In other words, the cell switch-off bit may be prioritized, such that if the cell switch-off DCI bit is enabled/activated (e.g., if set to ‘1’), then the other cell DTX/DRX bits are ignored.

According to aspects of the third solution, the enhanced cell DTX/DRX configuration enables an application time, T_{AP}, is defined for the cell turning off, wherein the cell turn-off is applied after T_{AP} time units (e.g., slots or ms) relative to the time of receiving the DCI. Under this approach, for a UE receiving the DCI at time slot n with indication corresponding to a cell being turned off, the UE expects the cell to be turned off after an application time.

In a first example, the UE expects the cell to be turned off T_{AP} ms after the beginning (or end) of slot n. In a second example, the UE expects the cell to be turned off T_{AP} ms after the end of slot n. In a third example, the UE expects the cell to be turned off T_{AP} slots after slot n.

In a first implementation of the third solution, the unit of application time, T_{AP}, is in the form of milliseconds or slot index. In a second implementation of the third solution, T_{AP} is higher-layer configured, wherein a value of T_{AP} is selected from a set of codepoints, e.g., {100, 200, 500, 1000, 2000, 4000, 5000, 10000} ms.

In a third implementation of the third solution, T_{AP} is a fixed value, e.g., 1000 ms. In a first example, the value of the application time is based on a subcarrier spacing (SCS) value of an OFDM signal, where the application time in an order of slots is proportional with the SCS value.

In a fourth implementation of the third solution, T_{AP} is L1 indicated in the DCI, wherein DCI Format 2_9 includes an additional field that indicates the application time value. In a first example, the codebook of values of the application time is included as part of a higher layer configuration corresponding to cell turn-off.

In a second example, the codebook of values of the application time is set by a rule, e.g., the rule is based on a SCS value of an OFDM signal, where the application time in an order of slots is proportional with the SCS value.

In a fifth implementation of the third solution, when cell DTX and/or cell DRX is configured, the UE expects (or assumes) the cell to be turned off at the start of the cell DRX/DTX active period and not before the beginning of a slot with a minimum time gap from the slot in which the DCI 2_9 cell turn-off indication with bit set to ‘1’ is received.

In a sixth implementation of the third solution, the UE expects (or assumes) the cell to be turned off at the start of the subframe/slot based on a cell turn-off start offset, and possibly cell turn-off cycle/period and slot offset and not before the beginning of a slot with a minimum time gap from the slot in which the DCI 2_9 cell turn-off indication with bit set to ‘1’ is received.

For example, if [(SFN×10)+subframe number] modulo (cellturnoff-Cycle)=(cellturnoff-StartOffset), then the UE expects (or assumes) the cell to be turned off after cellturnoff-SlotOffset from the beginning of the subframe.

In some examples, the value of the cell turn-off cycle/period may be fixed in specification e.g., 1 ms or based on the value of a timer (e.g., T310 timer). In some examples, cellturnoff-SlotOffset may not be configured (e.g., step 2>UE expects (or assumes) the cell to be turned off from the beginning of the subframe satisfying step 1>) or the value of the cell turn-off cycle/period may be fixed in specification.

In a seventh implementation of the third solution, the DCI format 2_9 may be received on a first serving cell indicating cell turn-off or NES-specific CHO execution condition indication for a second serving cell. The cell turn-off application time or subframe/slot is determined based on the subframe/slot of the first serving cell.

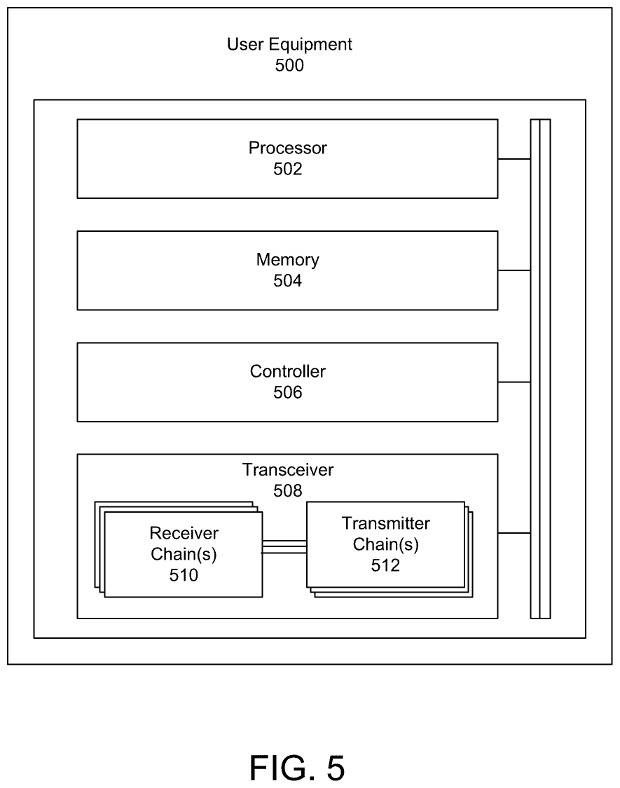

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502, cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the UE functions described herein (e.g., executing, by the processor 502, instructions stored in the memory 504). Accordingly, the processor 502 may support wireless communication at the UE 500 in accordance with examples as disclosed herein. For example, the UE 500 may be configured to support a means for receiving, e.g., from a network entity, a cell DTX/DRX configuration for a plurality of serving cells. In some embodiments, the cell DTX/DRX configuration comprises RRC signaling of a set of parameters for DTX/DRX operation in the cell.

The UE 500 may be configured to support a means for receiving a DCI signal for a serving cell corresponding to at least the cell DTX/DRX configuration, where the DCI includes an indication of a cell turn-off. In some embodiments, the DCI signal comprises a PDCCH transmission corresponding to a DCI format 2_9. In certain embodiments, a size of the DCI format 2_9 is configured by higher-layer signaling.

In some embodiments, the indication of the cell turn-off comprises an indication of a NES CHO. In some embodiments, the cell DTX/DRX configuration comprises a higher-layer parameter for a NES-specific CHO.

The UE 500 may be configured to support a means for performing a cell search based at least in part on the cell turn-off and the cell DTX/DRX configuration.

In some embodiments, the UE 500 is configured to receive a cell turn-off configuration for the at least one serving cell. In certain embodiments, both the cell DTX/DRX configuration and the cell turn-off configuration are higher-layer configured.

In some embodiments, the DCI signal comprises a plurality of blocks associated with the plurality of serving cells. In certain embodiments, a respective block of the plurality of blocks comprises a one-bit field indicating a cell turn-off operation based at least in part on: 1) a cell turn-off parameter being configured and 2) a cell DTX/DRX type parameter being unconfigured.

In certain embodiments, a respective block of the plurality of blocks comprises a one-bit field indicating a cell DTX/DRX operation based at least in part on: 1) a DTX/DRX type parameter being configured to either cell DTX or cell DRX and 2) a cell turn-off parameter being unconfigured.

In certain embodiments, a respective block of the plurality of blocks comprises a two-bit field indicating a cell DTX/DRX operation based at least in part on: 1) a cell DTX/DRX type parameter being configured to both cell DTX and cell DRX and 2) a cell turn-off parameter being unconfigured.

In certain embodiments, a respective block of the plurality of blocks comprises a two-bit field indicating a cell turn-off operation based at least in part on: a cell turn-off parameter being configured to either cell DTX or cell DRX (e.g., using a 1 bit), and further indicating a cell turn-off operation based at least in part on a cell turn-off parameter being configured.

In certain embodiments, a respective block of the plurality of blocks comprises a three-bit field indicating a cell DTX/DRX operation based at least in part on a cell DTX/DRX type parameter being configured to both cell DTX and cell DRX (e.g., using 2 bits), and further indicating a cell turn-off operation based at least in part on a cell turn-off parameter being configured.

In some embodiments, the UE 500 is configured to determine an application time of the cell turn-off for the serving cell. In certain embodiments, the UE 500 is further configured to ignore a transmission or a reception associated with the serving cell based at least in part on the cell turn-off application time.

In certain embodiments, the application time of the cell turn-off is configured from a set of candidate values or is indicated in the DCI signal. In certain embodiments, the UE 500 may compute the application time of the cell turn-off with reference to a reception time of the DCI signal. In other embodiments, the application time of the cell turn-off is set by a rule or a fixed value.

The controller 506 may manage input and output signals for the UE 500. The controller 506 may also manage peripherals not integrated into the UE 500. In some implementations, the controller 506 may utilize an operating system (OS) such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

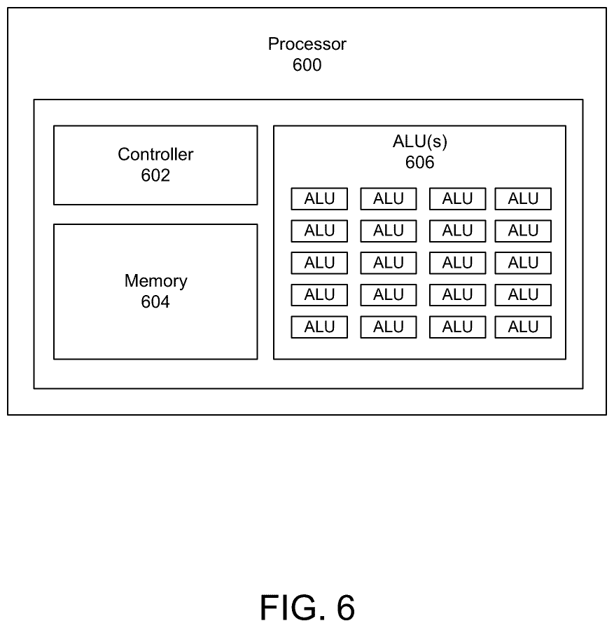

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

In various embodiments, the processor 600 may support wireless communication of a UE, in accordance with examples as disclosed herein. For example, the processor 600 may be configured to support a means for receiving, e.g., from a network entity, a cell DTX/DRX configuration for a plurality of serving cells. In some embodiments, the cell DTX/DRX configuration comprises RRC signaling of a set of parameters for DTX/DRX operation in the cell.

The processor 600 may be configured to support a means for receiving a DCI signal for a serving cell corresponding to at least the cell DTX/DRX configuration, where the DCI includes an indication of a cell turn-off. In some embodiments, the DCI signal comprises a PDCCH transmission corresponding to a DCI format 2_9. In certain embodiments, a size of the DCI format 2_9 is configured by higher-layer signaling.

In some embodiments, the indication of the cell turn-off comprises an indication of a NES CHO. In some embodiments, the cell DTX/DRX configuration comprises a higher-layer parameter for a NES-specific CHO.

The processor 600 may be configured to support a means for performing a cell search based at least in part on the cell turn-off and the cell DTX/DRX configuration.

In some embodiments, the processor 600 is configured to receive a cell turn-off configuration for the at least one serving cell. In certain embodiments, both the cell DTX/DRX configuration and the cell turn-off configuration are higher-layer configured.

In some embodiments, the DCI signal comprises a plurality of blocks associated with the plurality of serving cells. In certain embodiments, a respective block of the plurality of blocks comprises a one-bit field indicating a cell turn-off operation based at least in part on: 1) a cell turn-off parameter being configured and 2) a cell DTX/DRX type parameter being unconfigured.

In certain embodiments, a respective block of the plurality of blocks comprises a one-bit field indicating a cell DTX/DRX operation based at least in part on: 1) a DTX/DRX type parameter being configured to either cell DTX or cell DRX and 2) a cell turn-off parameter being unconfigured.

In certain embodiments, a respective block of the plurality of blocks comprises a two-bit field indicating a cell DTX/DRX operation based at least in part on: 1) a cell DTX/DRX type parameter being configured to both cell DTX and cell DRX and 2) a cell turn-off parameter being unconfigured.

In certain embodiments, a respective block of the plurality of blocks comprises a two-bit field indicating a cell turn-off operation based at least in part on: a cell turn-off parameter being configured to either cell DTX or cell DRX (e.g., using a 1 bit), and further indicating a cell turn-off operation based at least in part on a cell turn-off parameter being configured.

In certain embodiments, a respective block of the plurality of blocks comprises a three-bit field indicating a cell DTX/DRX operation based at least in part on a cell DTX/DRX type parameter being configured to both cell DTX and cell DRX (e.g., using 2 bits), and further indicating a cell turn-off operation based at least in part on a cell turn-off parameter being configured.

In some embodiments, the processor 600 is configured to determine an application time of the cell turn-off for the serving cell. In certain embodiments, the processor 600 is further configured to ignore a transmission or a reception associated with the serving cell based at least in part on the cell turn-off application time.

In certain embodiments, the application time of the cell turn-off is configured from a set of candidate values or is indicated in the DCI signal. In certain embodiments, the processor 600 may compute the application time of the cell turn-off with reference to a reception time of the DCI signal. In other embodiments, the application time of the cell turn-off is set by a rule or a fixed value.

In various implementations, the processor 600 may support the functions of a base station, in accordance with examples as disclosed herein. For example, the processor 600 may be configured to support a means for transmitting, e.g., to a set of one or more UEs, a cell DTX/DRX configuration for a plurality of serving cells. In some embodiments, the cell DTX/DRX configuration comprises RRC signaling of a set of parameters for DTX/DRX operation in the cell.

The processor 600 may be configured to support a means for transmitting a DCI signal for a serving cell corresponding to at least the cell DTX/DRX configuration, wherein the DCI signal further comprises an indication of a cell turn-off. In some embodiments, the DCI signal comprises a PDCCH transmission corresponding to a DCI format 2_9. In certain embodiments, a size of the DCI format 2_9 is configured by higher-layer signaling.

In some embodiments, the indication of the cell turn-off comprises an indication of a NES CHO. In some embodiments, the cell DTX/DRX configuration comprises a higher-layer parameter for a NES-specific CHO.

The processor 600 may be configured to support a means for deactivating the serving cell based at least in part on the cell turn-off and the cell DTX/DRX configuration.

In some embodiments, the processor 600 is configured to transmit (e.g., to the set of UEs) a cell turn-off configuration for the at least one serving cell. In certain embodiments, both the cell DTX/DRX configuration and the cell turn-off configuration are higher-layer configured.

In some embodiments, the DCI signal comprises a plurality of blocks associated with the plurality of serving cells. In certain embodiments, a respective block of the plurality of blocks comprises a one-bit field indicating a cell turn-off operation based at least in part on: 1) a cell turn-off parameter being configured and 2) a cell DTX/DRX type parameter being unconfigured.

In certain embodiments, a respective block of the plurality of blocks comprises a one-bit field indicating a cell DTX/DRX operation based at least in part on: 1) a DTX/DRX type parameter being configured to either cell DTX or cell DRX and 2) a cell turn-off parameter being unconfigured.

In certain embodiments, a respective block of the plurality of blocks comprises a two-bit field indicating a cell DTX/DRX operation based at least in part on: 1) a cell DTX/DRX type parameter being configured to both cell DTX and cell DRX and 2) a cell turn-off parameter being unconfigured.

In certain embodiments, a respective block of the plurality of blocks comprises a two-bit field indicating a cell turn-off operation based at least in part on: a cell turn-off parameter being configured to either cell DTX or cell DRX (e.g., using a 1 bit), and further indicating a cell turn-off operation based at least in part on a cell turn-off parameter being configured.

In certain embodiments, a respective block of the plurality of blocks comprises a three-bit field indicating a cell DTX/DRX operation based at least in part on a cell DTX/DRX type parameter being configured to both cell DTX and cell DRX (e.g., using 2 bits), and further indicating a cell turn-off operation based at least in part on a cell turn-off parameter being configured.

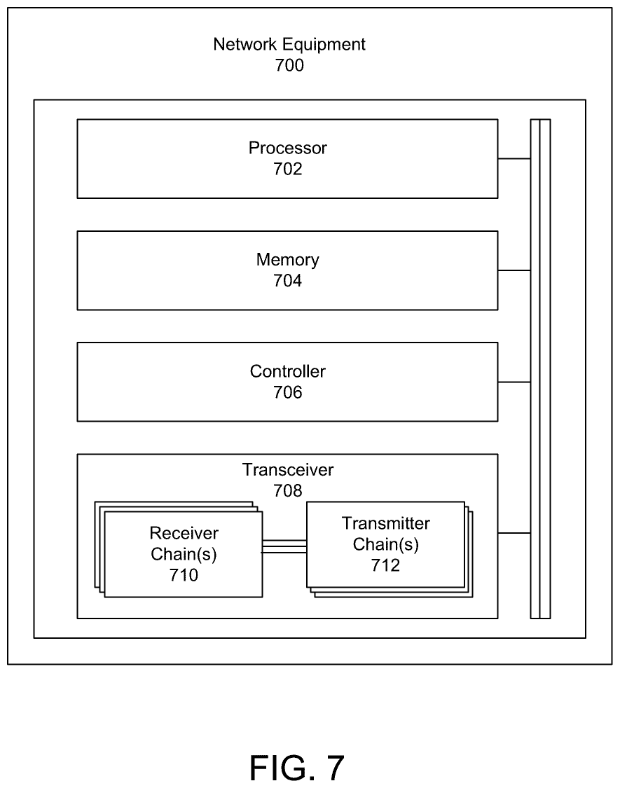

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the RAN functions described herein (e.g., executing, by the processor 702, instructions stored in the memory 704). Accordingly, the processor 702 may support wireless communication at the NE 700 in accordance with examples as disclosed herein. For example, the NE 700 may be configured to support a means for transmitting, e.g., to a set of one or more UEs, a cell DTX/DRX configuration for a plurality of serving cells. In some embodiments, the cell DTX/DRX configuration comprises RRC signaling of a set of parameters for DTX/DRX operation in the cell.

The NE 700 may be configured to support a means for transmitting a DCI signal for a serving cell corresponding to at least the cell DTX/DRX configuration, wherein the DCI signal further comprises an indication of a cell turn-off. In some embodiments, the DCI signal comprises a PDCCH transmission corresponding to a DCI format 2_9. In certain embodiments, a size of the DCI format 2_9 is configured by higher-layer signaling.

In some embodiments, the indication of the cell turn-off comprises an indication of a NES CHO. In some embodiments, the cell DTX/DRX configuration comprises a higher-layer parameter for a NES-specific CHO.

The NE 700 may be configured to support a means for deactivating the serving cell based at least in part on the cell turn-off and the cell DTX/DRX configuration.

In some embodiments, the NE 700 is configured to transmit (e.g., to the set of UEs) a cell turn-off configuration for the at least one serving cell. In certain embodiments, both the cell DTX/DRX configuration and the cell turn-off configuration are higher-layer configured.

In some embodiments, the DCI signal comprises a plurality of blocks associated with the plurality of serving cells. In certain embodiments, a respective block of the plurality of blocks comprises a one-bit field indicating a cell turn-off operation based at least in part on: 1) a cell turn-off parameter being configured and 2) a cell DTX/DRX type parameter being unconfigured.

In certain embodiments, a respective block of the plurality of blocks comprises a one-bit field indicating a cell DTX/DRX operation based at least in part on: 1) a DTX/DRX type parameter being configured to either cell DTX or cell DRX and 2) a cell turn-off parameter being unconfigured.

In certain embodiments, a respective block of the plurality of blocks comprises a two-bit field indicating a cell DTX/DRX operation based at least in part on: 1) a cell DTX/DRX type parameter being configured to both cell DTX and cell DRX and 2) a cell turn-off parameter being unconfigured.

In certain embodiments, a respective block of the plurality of blocks comprises a two-bit field indicating a cell turn-off operation based at least in part on: a cell turn-off parameter being configured to either cell DTX or cell DRX (e.g., using a 1 bit), and further indicating a cell turn-off operation based at least in part on a cell turn-off parameter being configured.

In certain embodiments, a respective block of the plurality of blocks comprises a three-bit field indicating a cell DTX/DRX operation based at least in part on a cell DTX/DRX type parameter being configured to both cell DTX and cell DRX (e.g., using 2 bits), and further indicating a cell turn-off operation based at least in part on a cell turn-off parameter being configured.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

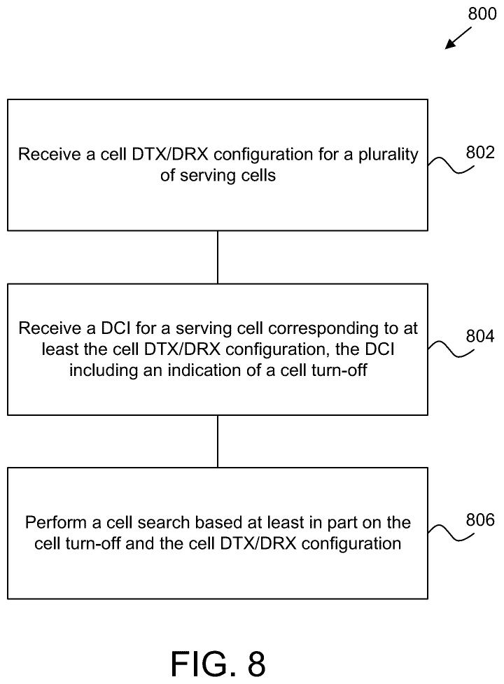

FIG. 8 depicts one embodiment of a method 800 in accordance with aspects of the present disclosure. The operations of the method 800 may be implemented by a UE as described herein. In some implementations, the UE may execute a set of instructions to control the function elements of the UE to perform the described functions.

At step 802, the method 800 may include receiving (e.g., from a base station) a cell DTX/DRX configuration for a plurality of serving cells. The operations of step 802 may be performed in accordance with examples as described herein. In some implementations, aspects of the operations of step 802 may be performed by a UE, as described with reference to FIG. 5.

At step 804, the method 800 may include receiving a DCI for a serving cell corresponding to at least the cell DTX/DRX configuration, the DCI including an indication of a cell turn-off. The operations of step 804 may be performed in accordance with examples as described herein. In some implementations, aspects of the operations of step 804 may be performed by a UE, as described with reference to FIG. 5.

At step 806, the method 800 may include performing a cell search based at least in part on the cell turn-off and the cell DTX/DRX configuration. The operations of step 806 may be performed in accordance with examples as described herein. In some implementations, aspects of the operations of step 806 may be performed by a UE, as described with reference to FIG. 5.

It should be noted that the method 800 described herein describes one possible implementation, and that the operations and the steps may be rearranged or otherwise modified and that other implementations are possible.

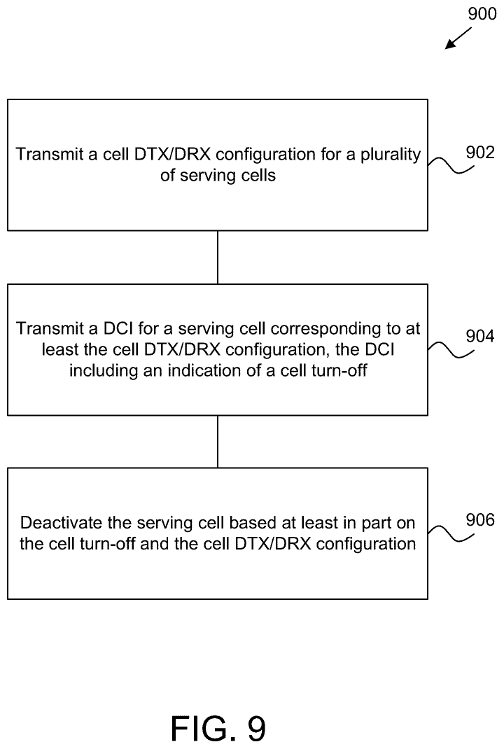

FIG. 9 depicts one embodiment of a method 900 in accordance with aspects of the present disclosure. The operations of the method 900 may be implemented by a NE as described herein. In some implementations, the NE may execute a set of instructions to control the function elements of the NE to perform the described functions.

At step 902, the method 900 may include transmitting (e.g., to a UE) a cell DTX/DRX configuration for a plurality of serving cells. The operations of step 902 may be performed in accordance with examples as described herein. In some implementations, aspects of the operations of step 902 may be performed by a NE, as described with reference to FIG. 7.

At step 904, the method 900 may include transmitting a DCI for a serving cell corresponding to at least the cell DTX/DRX configuration, the DCI including an indication of a cell turn-off. The operations of step 904 may be performed in accordance with examples as described herein. In some implementations, aspects of the operations of step 904 may be performed by a NE, as described with reference to FIG. 7.

At step 906, the method 900 may include deactivating the serving cell based at least in part on the cell turn-off and the cell DTX/DRX configuration. The operations of step 906 may be performed in accordance with examples as described herein. In some implementations, aspects of the operations of step 906 may be performed by a NE, as described with reference to FIG. 7.

It should be noted that the method 900 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A User Equipment (UE) for wireless communication, comprising:
at least one memory; and
at least one processor coupled with the at least one memory and configured to cause the UE to:
receive, from a network entity, a cell discontinuous transmission and/or reception (DTX/DRX) configuration for a plurality of serving cells;
receive a downlink control information (DCI) signal for a serving cell corresponding to at least the cell DTX/DRX configuration, wherein the DCI signal further comprises an indication of a cell turn-off; and
perform a cell search based at least in part on the cell turn-off and the cell DTX/DRX configuration.

2. The UE of claim 1, wherein the indication of the cell turn-off comprises an indication of a network energy savings (NES) conditional handover (CHO).

3. The UE of claim 1, wherein the cell DTX/DRX configuration comprises radio resource control (RRC) signaling, and wherein the DCI signal comprises a physical downlink control channel (PDCCH) transmission corresponding to a DCI format 2_9.

4. The UE of claim 3, wherein a size of the DCI format 2_9 is configured by higher-layer signaling.

5. The UE of claim 1, wherein the cell DTX/DRX configuration comprises a higher-layer parameter for a network energy savings (NES) specific CHO.

6. The UE of claim 1, wherein the at least one processor is configured to cause the UE to receive a cell turn-off configuration for the at least one serving cell, wherein both the cell DTX/DRX configuration and the cell turn-off configuration are higher-layer configured.

7. The UE of claim 1, wherein the DCI signal comprises a plurality of blocks associated with the plurality of serving cells, wherein a respective block of the plurality of blocks comprises a one-bit field indicating a cell DTX/DRX operation based at least in part on a DTX/DRX type parameter being configured to cell discontinuous transmission (DTX) or cell discontinuous reception (DRX) and a cell turn-off parameter being unconfigured.

8. The UE of claim 1, wherein the DCI signal comprises a plurality of blocks associated with the plurality of serving cells, wherein a respective block of the plurality of blocks comprises a one-bit field indicating a cell turn-off operation based at least in part on a cell turn-off parameter being configured and a cell DTX/DRX type parameter being unconfigured.

9. The UE of claim 1, wherein the DCI signal comprises a plurality of blocks associated with the plurality of serving cells, wherein a respective block of the plurality of blocks comprises a two-bit field indicating a cell DTX/DRX operation based at least in part on a cell DTX/DRX type parameter being configured to cell discontinuous transmission (DTX) and discontinuous reception (DRX) and a cell turn-off parameter being unconfigured.

10. The UE of claim 1, wherein the DCI signal comprises a plurality of blocks associated with the plurality of serving cells, wherein a respective block of the plurality of blocks comprises a two-bit field indicating a cell turn-off operation based at least in part on a cell turn-off parameter being configured to cell discontinuous transmission (DTX) or cell discontinuous reception (DRX) and further indicating a cell turn-off operation based at least in part on a cell turn-off parameter being configured.

11. The UE of claim 1, wherein the DCI signal comprises a plurality of blocks associated with the plurality of serving cells, wherein a respective block of the plurality of blocks comprises a three-bit field indicating a cell DTX/DRX operation based at least in part on a cell DTX/DRX type parameter being configured to cell discontinuous transmission (DTX) and cell discontinuous reception (DRX), and further indicating a cell turn-off operation based at least in part on a cell turn-off parameter being configured.

12. The UE of claim 1, wherein the at least one processor is configured to cause the UE to determine an application time of the cell turn-off for the serving cell.

13. The UE of claim 12, wherein the at least one processor is configured to cause the UE to ignore a transmission or a reception associated with the serving cell based at least in part on the application time of the cell turn-off.

14. The UE of claim 12, wherein the application time of the cell turn-off is computed with reference to a reception time of the DCI signal, and wherein the application time of the cell turn-off is set by a rule or a fixed value.

15. The UE of claim 12, wherein the application time of the cell turn-off is configured from a set of candidate values or is indicated in the DCI signal.

16. A processor for wireless communication, comprising:
at least one controller coupled with at least one memory and configured to cause the processor to:
receive, from a network entity, a cell discontinuous transmission and/or reception (DTX/DRX) configuration for a plurality of serving cells;
receive a downlink control information (DCI) signal for a serving cell corresponding to at least the cell DTX/DRX configuration, wherein the DCI signal further comprises an indication of a cell turn-off; and
perform a cell search based at least in part on the cell turn-off and the cell DTX/DRX configuration.

17. A base station for wireless communication, comprising:
at least one memory; and
at least one processor coupled with the at least one memory and configured to cause the base station to:
transmit, to at least one user equipment (UE), a cell discontinuous transmission and/or reception (DTX/DRX) configuration for a plurality of serving cells;
transmit a downlink control information (DCI) signal for a serving cell corresponding to at least the cell DTX/DRX configuration, wherein the DCI signal further comprises an indication of a cell turn-off; and
deactivate the serving cell based at least in part on the cell turn-off and the cell DTX/DRX configuration.

18. The base station of claim 17, wherein the indication of the cell turn-off comprises an indication of a network energy savings (NES) conditional handover (CHO), and wherein the cell DTX/DRX configuration comprises a higher-layer parameter for a NES-specific CHO.

19. The base station of claim 17, wherein the cell DTX/DRX configuration comprises radio resource control (RRC) signaling, wherein the DCI signal comprises a physical downlink control channel (PDCCH) transmission corresponding to a DCI format 2_9, and wherein a size of the DCI format 2_9 is configured by higher-layer signaling.

20. A method performed by a base station, the method comprising:
transmitting, to a user equipment (UE), a cell discontinuous transmission and/or reception (DTX/DRX) configuration for a plurality of serving cells;
transmitting a downlink control information (DCI) signal for a serving cell corresponding to at least the cell DTX/DRX configuration, wherein the DCI signal further comprises an indication of a cell turn-off; and
deactivating the serving cell based at least in part on the cell turn-off and the cell DTX/DRX configuration.
